(19) United States
(12) Patent Application Publication
(10) Pub. No.: US 2009/0102723 A1
(43) Pub. Date: Apr. 23, 2009

(54) Dual moded stacked microstrip patch antenna

(76) Inventors: Duane N. Mateychuk, Westfield, IN (US); John Z. Lu, Kokomo, IN (US)

Correspondence Address: DELPHI TECHNOLOGIES, INC., M/C 480-410-202, PO BOX 5052, TROY, MI, 48007, US

(21) Appl. No.: 11/975,365

(22) Filed: Oct. 18, 2007

(51) Int. Cl. H01Q 1/38

(52) U.S. Cl. 343/700 MS

(57) ABSTRACT

A dual moded stacked microstrip patch antenna includes an integrated first lower antenna element having probes excited at a higher transverse magnetic order mode and a second upper antenna element with probes excited at a lower order transverse magnetic mode. Distinct probe locations and phase offset signals are supplied to each of the probes in each of the first and second antenna elements to support the higher and lower order mode of operation.

### BACKGROUND OF THE INVENTION

1. Field of Invention

The present invention relates to an antenna mounted on a movable body which is capable of receiving both satellite and terrestrial signals.

2. Description of the Related Art

Satellite broadcasts of radio programs and/or GPS signals to moveable bodies, such as automobiles, have become more popular in recent years.

Such satellite broadcast systems typically employ circularly polarized signals. Circularly polarized patch antennas provide this feature.

A separate antenna for ground radio station broadcast signals, such as a helical or rod antenna or a vertically polarized wave antenna have been proposed for receiving such ground broadcast signals.

As with any component mounted on an automobile, size, reliability, ease of mounting on non-planar surfaces, are essential features for mounting any component, and in particular, an antenna to the automobile. Size constraints alone have limited the size of prior patch antennas resulting in a low gain which contributes to intermittent muting and signal outages.

In addition, satellite system antennas are used across the globe and can pose problems depending upon their geographic latitude of use. Low latitude applications require antennas with a wide beam in the vertical direction. This requirement does not pose significant difficulty. At higher latitudes (example U.S.), however, geo-stationary satellites can be seen at elevation angles ranging between 65° down to 20°. Mobile antennas which have maximum directivity at an elevation of approximately 45° can maximize performance. One such antenna has a conical radiation pattern which can be provided by a circular array or with circular/annular elements operating at higher order modes. It is known that patch antennas operating at higher resonant modes present a more compact design. However, despite these advantages, the efficiency of such antennas is still limited.

### SUMMARY

A microstrip patch antenna apparatus includes a ground plane; a first antenna element having a first patch electrode mounted on a first substrate, the first substrate mounted on the ground plane; a first feed conductor extending through the ground plane and the first substrate to electrical connection with the first patch electrode, the feed connection exciting the first electrode in a higher order transverse magnetic mode, a second antenna element mounted on the first antenna element, the second antenna element having a second patch electrode and a second substrate mounted on the first antenna element, and a second feed conductor extending through the ground plane, the first substrate and the second substrate to electrical connection with the second patch electrode, the second feed conductor exciting the second patch electrode in a lower order transverse magnetic mode.

The first feed conductor includes, in one aspect, a first set of four probes extending through the ground plane and the first substrate and connected to the first patch electrode at different circumferentially spaced intervals. The second feed electrode, in one aspect, includes a second set of at least two probes extending through the ground plane, the first substrate and the second substrate and connected to the second patch electrode at circumferentially spaced intervals. Each of the first set of probes are driven at different relative phase angles forcing the first patch electrode to generate a right hand circularly polarized higher order transverse magnetic mode radiation patterns; and each of the second set of probes is driven at different relative phase angles forcing the second patch electrode to generate a right hand circularly polarized lower order transverse magnetic mode radiation pattern.

The second set of probes are excited to generate a lower order dual TM10 or TM11 radiation pattern.

The first feed conductors may include four probes disposed at spaced angles and driven at different phase angles to cause the first patch electrode to generate a higher order TM21, TM3 or TM41 mode or radiation pattern.

A second set of probes include two probes which are driven at different relative phase angles forcing the second patch electrode to generate a right hand circularly polarized lower order transverse magnetic mode radiation pattern.

### BRIEF DESCRIPTION OF THE DRAWINGS

The various features, advantages and other uses of the stacked dual mode microstrip patch antenna will become more apparent by referring to the following detailed description and drawing in which:

FIG. 1 is a general perspective view of a stacked dual mode microstrip patch antenna;

FIG. 2 is a longitudinal cross sectional view generally taken along the line 2-2 in FIG. 1;

FIG. 3 is a plan view of one aspect of a stacked dual mode microstrip patch antenna;

FIG. 4 is an exploded perspective view of the upper and lower antenna elements of the antenna shown in FIG. 3;

FIG. 5A is a plan view of the upper antenna element depicted in FIGS. 3 and 4 showing the probe feed locations;

FIG. 5B is a plan view of the lower antenna element depicted in FIGS. 3 and 4 showing the probe feed locations;

FIG. 6 is a graph depicting circular polarized directivity versus degree angles for the patch antenna shown in FIGS. 3 and 4;

FIG. 7 is a plan view of another aspect of a stacked dual mode microstrip patch antenna;

FIG. 8 is an exploded perspective view of the upper and lower antenna elements of the antenna shown in FIG. 7;

FIG. 9A is a plan view of the upper antenna element depicted in FIGS. 7 and 8 showing the probe feed locations;

FIG. 9B is a plan view of the lower antenna element depicted in FIGS. 7 and 8 showing the probe feed locations;

FIG. 10 is a graph depicting circular polarized directivity versus degree angles for the patch antenna shown in FIGS. 7 and 8;

FIG. 11 is a plan view of another aspect of a stacked dual mode microstrip patch antenna;

FIG. 12 is an exploded perspective view of the upper and lower antenna elements of the antenna shown in FIG. 11;

FIG. 13A is a plan view of the upper antenna element depicted in FIGS. 11 and 12 showing the probe feed locations;

FIG. 13B is a plan view of the lower antenna element depicted in FIGS. 11 and 12 showing the probe feed locations;

FIG. 14 is a graph depicting circular polarized directivity versus degree angles for the patch antenna shown in FIGS. 11 and 12;

FIG. 15 is a plan view of another aspect of a stacked dual mode microstrip patch antenna;

FIG. 16 is an exploded perspective view of the upper and lower antenna elements of the antenna shown in FIG. 15;

FIG. 17A is a plan view of the upper antenna element depicted in FIGS. 15 and 16 showing the probe feed locations;

FIG. 17B is a plan view of the lower antenna element depicted in FIGS. 15 and 16 showing the probe feed locations;

FIG. 18 is a graph depicting circular polarized directivity versus degree angles for the patch antenna shown in FIGS. 15 and 16;

FIG. 19 is a plan view of another aspect of a stacked dual mode microstrip patch antenna;

FIG. 20 is an exploded perspective view of the upper and lower antenna elements of the antenna shown in FIG. 19;

FIG. 21A is a plan view of the upper antenna element depicted in FIGS. 19 and 20 showing the probe feed locations;

FIG. 21B is a plan view of the lower antenna element depicted in FIGS. 19 and 20 showing the probe feed locations;

FIG. 22 is a graph depicting circular polarized directivity versus degree angles for the patch antenna shown in FIGS. 19 and 20;

FIG. 23 is a plan view of another aspect of a stacked dual mode microstrip patch antenna;

FIG. 24 is an exploded perspective view of the upper and lower antenna elements of the antenna shown in FIG. 23;

FIG. 25A is a plan view of the upper antenna element depicted in FIGS. 23 and 24 showing the probe feed locations;

FIG. 25B is a plan view of the lower antenna element depicted in FIGS. 23 and 24 showing the probe feed locations; and

FIG. 26 is a graph depicting circular polarized directivity versus degree angles for the patch antenna shown in FIGS. 23 and 24.

### DETAILED DESCRIPTION

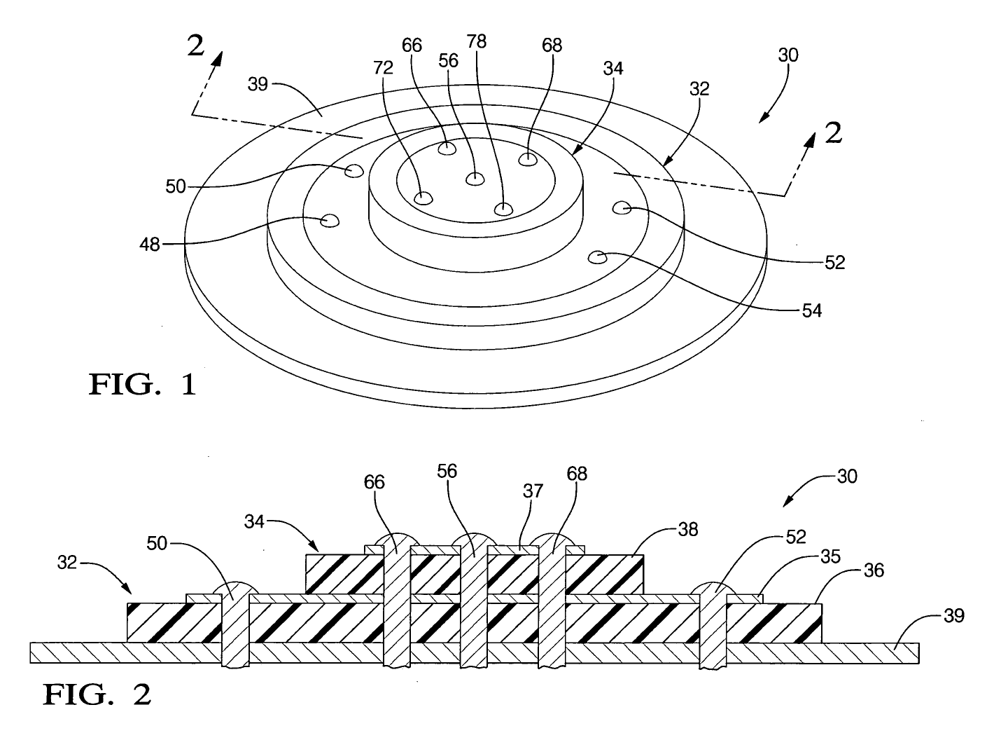

Referring now to FIGS. 1 and 2 a general view of a stacked dual mode microstrip patch antenna 30 is illustrated which includes two stacked antenna elements 32 and 34. The first or bottom antenna element 32 is a circular polarized higher order transverse magnetic mode antenna for receiving low elevation satellite and terrestrial signals. The second or upper antenna element 34 is a circular polarized lower order transverse magnetic mode circular patch antenna used to receive satellite signals. The antenna elements 32 and 34 can provide separate outputs for the terrestrial reception and the satellite reception or a combined output allowing selection of either terrestrial or satellite reception.

The second antenna element 34 is smaller in overall size than the outer dimensions of the first antenna element 32 and is stacked generally coaxially on top of and fixed to the first antenna element 32 by adhesive, over-molding, etc.

The first antenna element 32 includes a patch electrode 35 formed of a conductive material. The patch electrode 35 is fixed to a substrate 36 typically formed of an electrical insulator material, such as a printed circuit board material, ceramic, etc. The patch electrode 35 can be deposited on the substrate 36 by electroplating, thick film sputtering, soldering, etc. The substrate 36 is fixed to a conductive ground plane 39 which carries circuit components, conductive traces, etc. The second antenna element 34 includes a patch electrode 37 fixed to a substrate 38. The second upper antenna element 34 uses the electrode 35 of the first lower antenna element 32 as a ground plane.

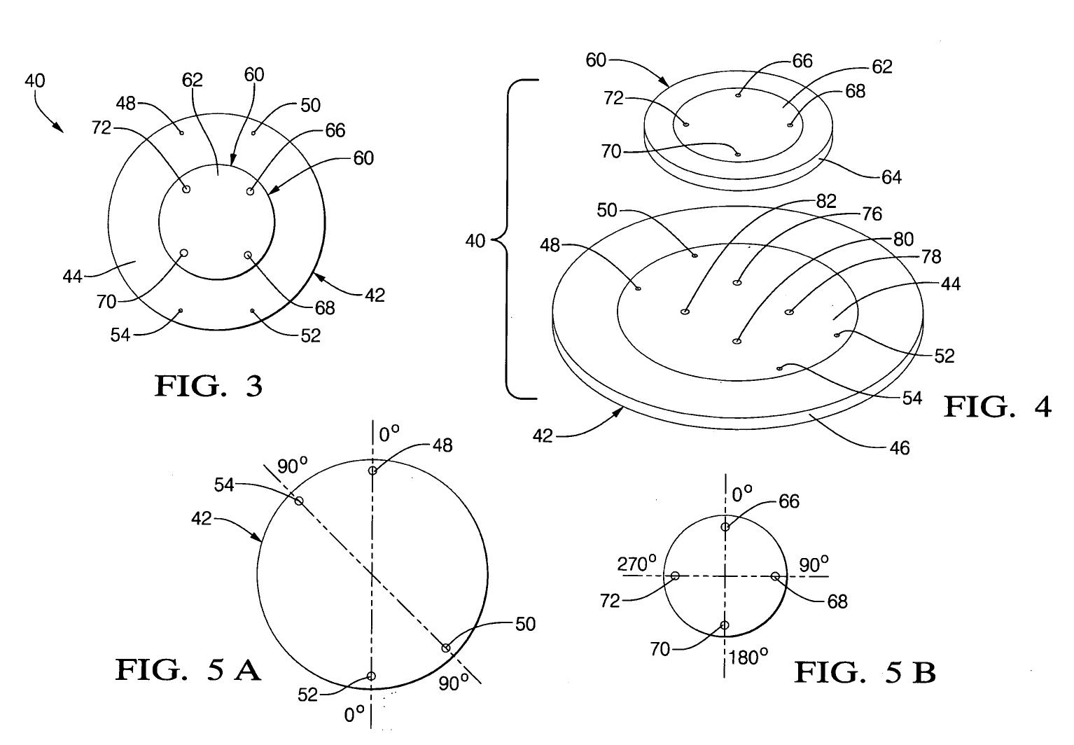

In the aspect of a stacked dual mode microstrip patch antenna 40 shown in FIGS. 3-5, the first antenna element 42 is a higher order TM21 moded circular patch antenna and a second or upper antenna element 60 is a lower order TM11 moded circular patch antenna. The first antenna element 42 includes a patch electrode 44 fixed to a substrate 46. The substrate 46 has a permittivity of er=2.2 and a thickness of 180 mils by example only.

In this aspect, the patch electrode 44 for the first antenna element 42 has a diameter of about 3,250 mils for the desired center frequency of the TM21 mode.

The first bottom patch antenna element 42 includes a plurality of probe feed point bores, with four probe feed point bores 48, 50, 52, and 56 being used to reinforce the higher order TM21 mode of operation, by way of example only. The bores can be formed by punching, laser cutting, drilling or by other processes.

The bores 48, 50, 52 and 54 for the probe feed points are about 1,450 mils from the patch center, by example only, and at a specific angular location with respect to the patch electrode center.

Starting at an angular position of 0°, the first probe in bore 48 receives a 0° phase offset signal. Located at an angular position of 135°, a 90° phase offset signal is supplied to the probe in bore 50. At an angular position of 180°, a 0° phase offset signal is supplied to the probe in bore 52. Finally, a 90° phase offset signal is supplied to the fourth probe in bore 54 located at an angular position of 315°. This angular arrangement places the second and third probes 50 and 52 45° apart and the fourth and first probes 56 and 48 45° apart.

An optional shorting pin 56 is located at the center of the electrode 42 and electrically connected to the electrode in the bottom antenna element to diminish undesirable modes that are non-zero at the bottom patch electrode center.

All of the probes mounted in the four feed point bores 48, 50, 52 and 54 can be combined with a passive feed network, not shown, to a single feed or two or more separate feeds. The probes can be in the form of the illustrated pin which is soldered to the electrodes or can be a plated hole type pin. Aperture feeding can also be used.

The probe or feed pin positions and phase angles of the feed signals may act to suppress the lower order TM11 mode at the higher order TM21 patch electrode 44.

A simulation of the TM21 moded first patch antenna element 42 shows a null at bore site (normal to antenna surface) and a maximum at about 42°. The half power beam width (HPBW) covers from approximately 20° to 70°. The directivity is about 5.0 to 5.5 dBi.

The upper, second antenna element 60 is formed as a lower order TM11 moded patch antenna having an electrode 62 and a finite substrate 64 having a diameter of 3,000 mils, a permittivity of er=3.4 and a thickness of 180 mils, all by example. Simulated data determined that the patch antenna electrode 62 should have a diameter of about 1,700 mils for the desired center frequency.

The TM11 mode antenna element 60 uses a plurality of probe feed points or feed conductors, with four probe feed point bores 66, 68, 70 and 72 being shown by way of example to reinforce the desired TM11 mode. These feed point bores 66, 68, 70 and 72 are about 700 mils from the patch electrode center, by example, and at a specific angular location with respect to the patch center.

Starting at an angular position of 0°, a 0° phase offset signal is supplied to the probe in the first feed point bore 66. At an angular position of 90°, a 90° phase offset signal is supplied to the probe in the second feed point bore 68. A 180° phase offset signal is supplied to the probe in the third probe feed point bore 70 located at an angular position of 180°. Finally, at an angular position of 270°, a 270° phase offset signal is supplied to the probe in the fourth probe feed point bore 72.

The probes mounted in the feed point bores 66, 68, 70 and 72 may be combined with a passive feed network into a single feed or separated into two or more feeds.

Bores 76, 78, 80 and 82 are formed in the electrode 42 and in the substrate 44 of the first antenna element 40 for passage of the probes through the first antenna element 40 into the feed bores 66, 68, 70 and 72 in electrical contact with the patch electrode 62 of the second antenna element 60.

The TM11 moded patch antenna 60 was directed at bore site (normal to antenna surface). The half power beam width (HPWB) covers from approximately −39° to +39°. The directivity was about 8.0 dBi.

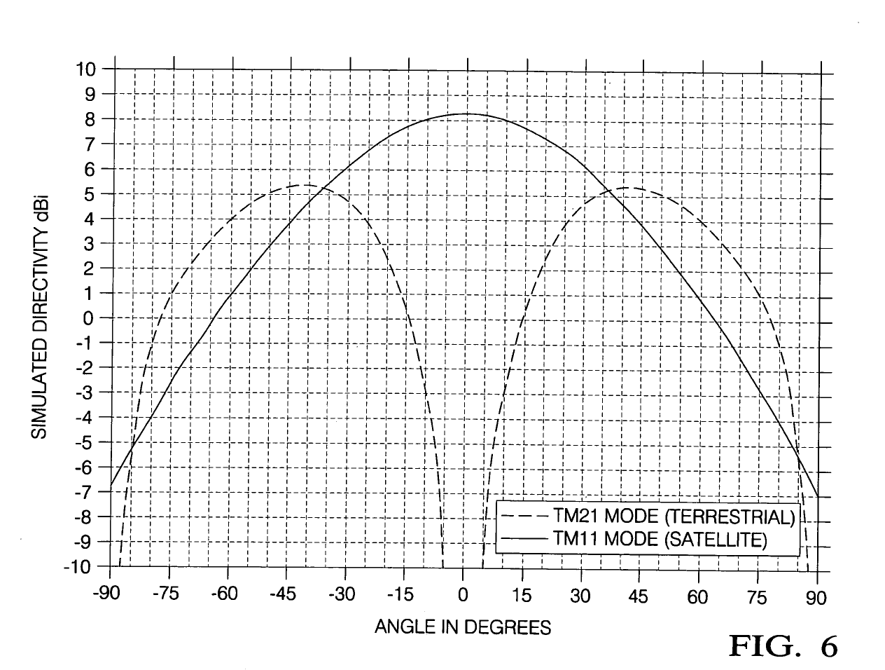

The radiation pattern for circular polarized directivity is shown in the graph in FIG. 6 for both antenna elements 42 and 60. As the higher order first antenna element 42 has a higher null at zenith, the lower order second antenna element 60 is centered on the first antenna element 42.

Simulations show that the antenna 40 should provide about +6 dB in satellite signal gain improvement and a significantly improved angular coverage to low observation angles (close to horizontal) for terrestrial signals.

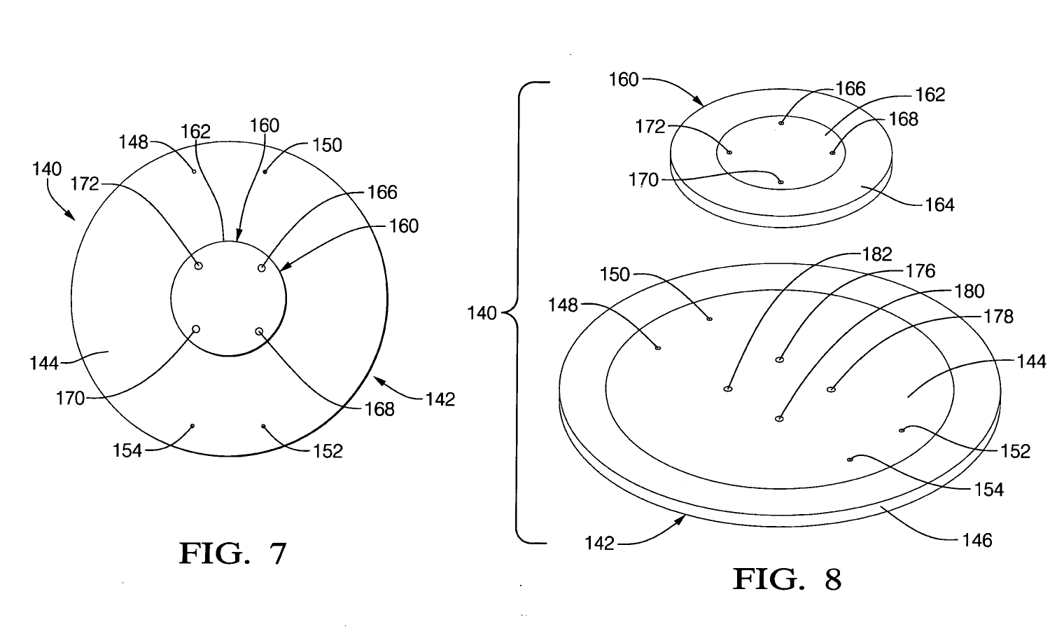

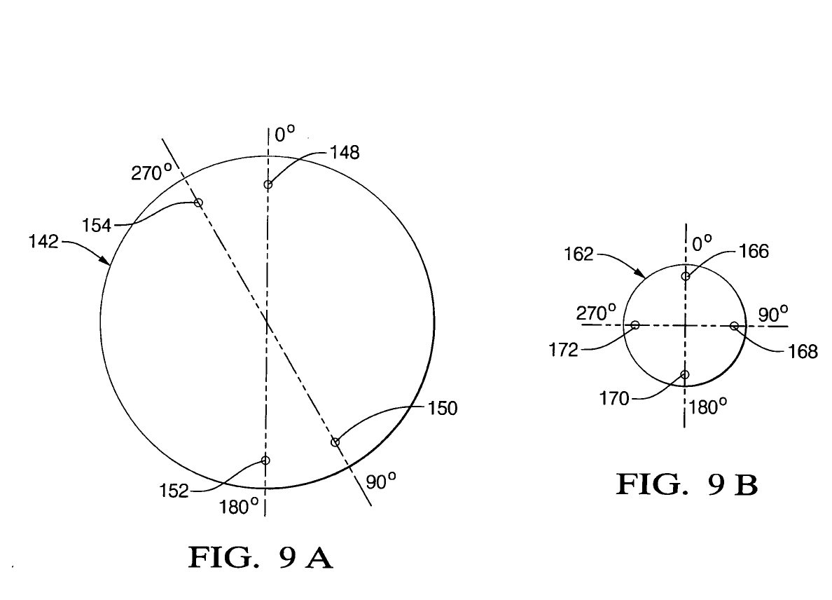

In another aspect of the stacked dual mode microstrip patch antenna denoted by reference number 140 in FIGS. 7-9B, a first lower antenna element 142 is a higher order TM31 moded circular patch antenna and a second or upper antenna element 160 is a lower order TM11 moded circular patch antenna identical to the lower order TM11 second antenna element 60 described above and shown in the antenna 110 depicted in FIGS. 3-6. The first antenna element 142 includes a patch electrode 144 fixed to a substrate 146. The substrate 146 has a permittivity of er=2.2 and a thickness of 180 mils by example only.

In this aspect, the patch electrode 144 for the first antenna element 142 has a diameter of about 4,700 mils for the desired center frequency of the TM31 mode.

An optional shorting pin is located at the center of the electrode 142 and electrically connected to the electrode in the bottom antenna element to diminish undesirable modes that are non-zero at the patch electrode center.

The first bottom patch antenna element 142 includes a plurality of probe feed bores, with four probe feed point bores 148, 150, 152 and 154 used to reinforce the desired higher order mode of operation, by way of example only.

The bores 148, 150, 152 and 154 for the probe feed points are about 1,950 mils from the patch center, by example only, and at a specific angular location with respect to the patch electrode center.

Starting at an angular position of 0°, the first probe in bore 148 receives a 0° phase offset signal. Located at an angular position of 150°, a 90° phase offset signal is supplied to the probe in bore 150. At an angular position of 180°, a 180° phase offset signal is supplied to the probe in bore 152. Finally, a 270° phase offset signal is supplied to the fourth probe in the bore 154 located at an angular position of 330°. This angular arrangement places the second and third probes 150 and 152 30° apart and the fourth and first probes 154 and 148 30° apart.

All of the probes mounted in the four feed point bores 148, 150, 152 and 154 can be combined with a passive feed network, not shown, to a single feed or two or more separate feeds. The probes or feed pin positions and phase angles of the feed signals may act to suppress the lower order TM11 mode of the higher order TM31 patch electrode 444.

A simulation of the TM31 moded patch antenna element 142 shows a null at bore site (normal to antenna surface) and a maximum at about 55°. The half power beamwidth (HPBW) covers from approximately 31 to 82°. The directivity is about 4.0 to 4.5 dBi.

The upper or second antenna element 160 is formed as a lower order TM11 moded patch antenna having an electrode 162 and a finite substrate 164 having a diameter of about 3,000 mils, a permittivity of er=3.4, and a thickness of about 180 mils, all by example. The simulated data determined that the patch antenna electrode 162 should have a diameter of about 1,700 mils for the desired center of frequency.

The TM11 mode antenna element 160 uses a plurality of probe feed points, with four probe feed point bores 166, 168, 170 and 172 shown by way of example to reinforce the desired TM11 mode. These feed points 166, 168, 170 and 172 are about 700 mils from the patch electrode center, by example, and at a specific angular location with respect to the patch center.

Starting at an angular position of 0°, a 0° phase offset signal is supplied to the first feed point bore 166. At an angular position of 90°, a 90° phase offset signal is supplied to the second feed point probe in bore 168. A 180° phase offset signal is supplied to the third probe feed point bore located at an angular position of 180°. Finally, at an angular position of 270°, a 270° phase offset signal is supplied to the fourth probe feed point bore 172.

The probes mounted in the feed points 166, 168, 170 and 172 may be combined with a passive feed network into a single feed or separated into two or more feeds.

Bores 176, 178, 180 and 182 are formed in the electrode 162 and in the substrate 144 of the first antenna element 140 for passage of the probes through the first antenna element 140 and into the feed location bores 166, 168, 170 and 172 in electrical contact with the electrode 162 of the second antenna element 160.

The TM11 moded patch antenna 160 was directed at bore site (normal to antenna surface). The half power beam width (HPWB) covers from approximately −39° to +39°. The directivity was about 8.0 dBi.

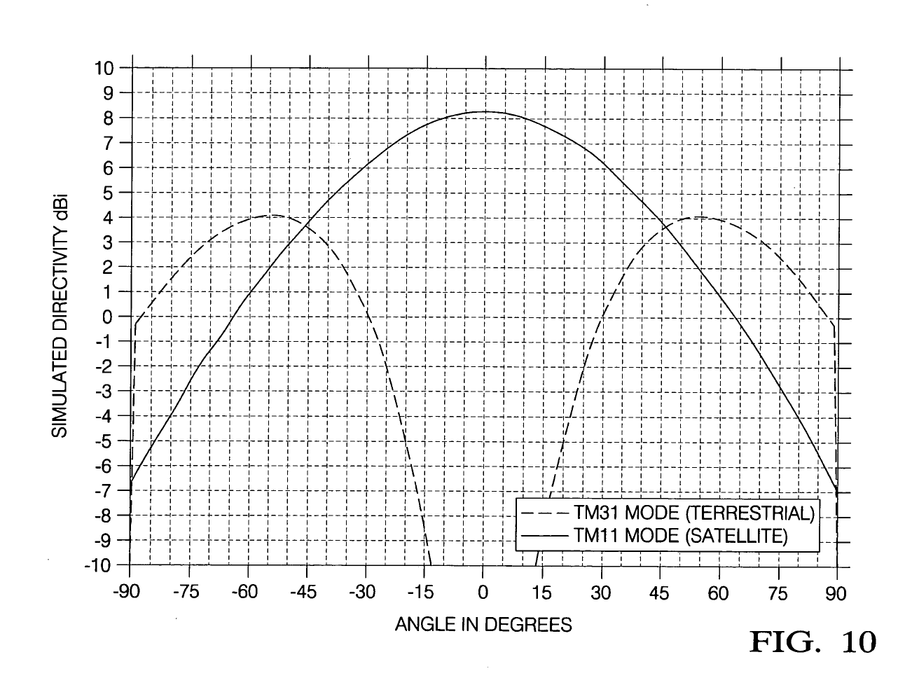

The radiation pattern for circular polarized directivity is shown in the graph in FIG. 10 for both antenna elements 142 and 160.

Simulations show that the antenna 140 should provide about +6 dB in satellite signal gain improvement and a significantly improved angular coverage to low observation angle (close to horizontal) for terrestrial signals.

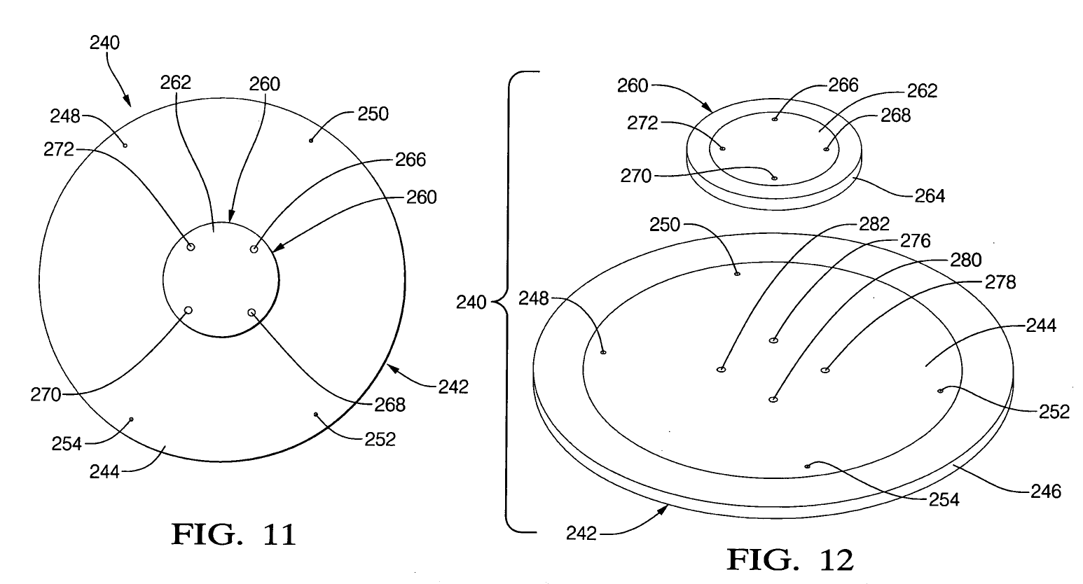

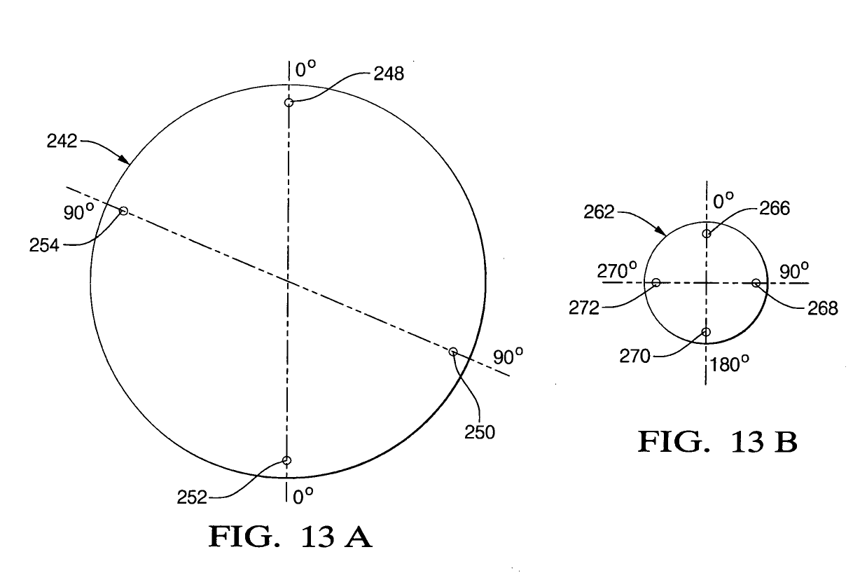

In another aspect of an antenna 240 shown in FIGS. 11-14, a first antenna element 242 is a higher order TM41 moded circular patch antenna and the second or upper antenna element 260 is a lower order TM11 moded circular patch antenna. In this aspect the first antenna element 242 has an electrode 244 fixed to a substrate 246. The substrate 246 has a permittivity of er=2.2 and a thickness of about 180 mils. by example. The patch electrode 244 has a diameter of about 5,500 mils for the desired center frequency of the TM41 mode.

Bores 248, 250, 252 and 254 for the probe feed points are about 2,500 mils from the patch center, by example only, and at a specific angular location with respect to the patch electrode center.

Starting at an angular position of 0°, the first probe in the bore 248 receives a 0° phase offset signal. Located at an angular position of 112.5°, a 90° phase offset signal is supplied to the probe in the bore 256. At an angular position of 180°, a 0° phase offset signal is supplied to the probe in bore 252. Finally, a 90° offset phase signal is supplied to the fourth probe in bore 254 located at an angular position of 292.5°. This angular arrangement places the second and third probes in bores 250 and 252 67.5° apart and the fourth and first probes in bores 254 and 246 67.5° apart.

An optional shorting pin is located at the center of the electrode 242 and electrically connected to the electrode in the bottom antenna element to diminish undesirable modes that are non-zero at the patch electrode center.

All of the probes mounted in the four feed point bores 248, 250, 252 and 254 can be combined with a passive feed network, not shown, to a single feed or two or more separate feeds. The probes or feed pin positions and phase angles of the feed signals may act to suppress the lower order TM11 mode of the higher order TM41 patch electrode 244.

A simulation of the TM41 moded first patch antenna element 242 shows a null at bore site (normal to antenna surface) and a maximum at about 60°. The half power beamwidth (HPBW) covers from approximately 40° to 80°. The directivity is about 4.5 to 5.0 dBi.

The upper, second antenna element 260 is formed as a lower order TM11 moded patch antenna having an electrode 262 and a finite substrate 264 having a diameter of about 3,000 mils, a permittivity of er=3.4 and a thickness of 180 mils, all by example. Simulated data determined that the patch antenna electrode 262 should have a diameter of about 1,700 mils for the desired center frequency.

The TM11 mode antenna element 260 uses a plurality of probe feed points, with four probe feed points or bore 266, 268, 270 and 272 being shown by way of example to reinforce the desired TM11 mode. These feed point bores 266, 268, 270 and 272 are about 700 mils from the patch electrode center, by example, and at a specific angular location with respect to the patch center.

Starting at an angular position of 0°, a 0° phase offset signal is supplied to the first feed point probe in the bore probe 266. At an angular position of 90°, a 90° phase offset signal is supplied to the second feed point bore in 268. A 180° phase offset signal is supplied to the third probe bore 270 located at an angular position of 180°. Finally, at an angular position of 270°, a 270° phase offset signal is supplied to the fourth probe in bore 272.

The probes mounted in the feed point bores 266, 268, 270 and 272 may be combined with a passive feed network into a single feed or separated into two or more feeds.

Bores 276, 278, 280 and 282 are formed in the electrode 242 and in the substrate 244 of the first antenna element 240 for passage of the probes through the first antenna element 240 into the feed bores 266, 268, 270 and 272 in electrical contact or communication with the patch electrode 262 of the second antenna element 260.

The TM11 moded patch antenna 260 was directed at bore site (normal to antenna surface). The half power beam width (HPWB) covers from approximately −39° to +39°. The directivity was about 8.0 dBi.

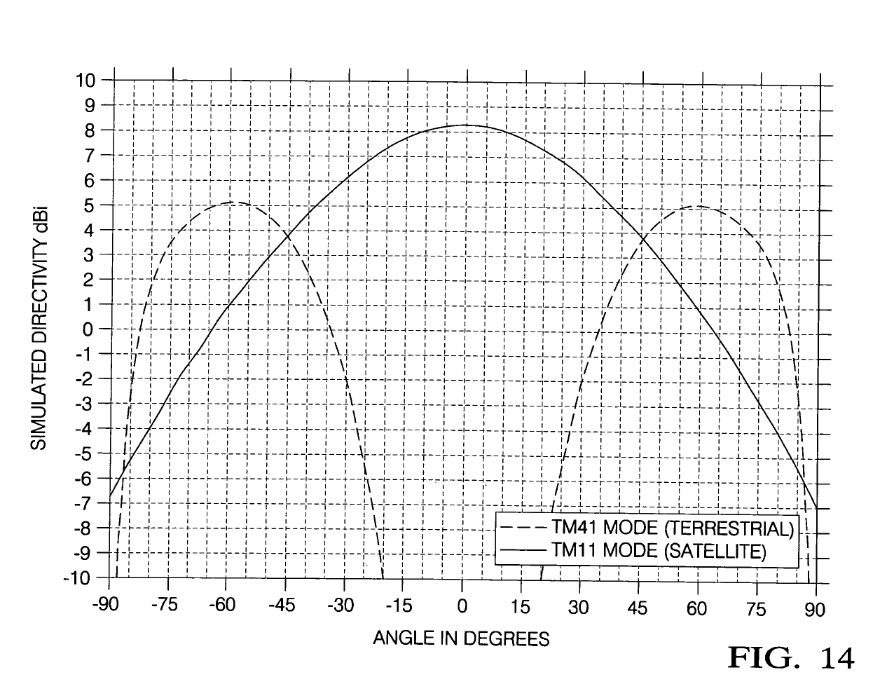

The radiation pattern for circular polarized directivity is shown in the graph in FIG. 14 for both antenna elements 242 and 260.

Simulations show that the patch antenna 240 should provide about +6 dB in satellite signal gain improvement and a significantly improved angular coverage to low observation angles (close to horizontal) for terrestrial signals.

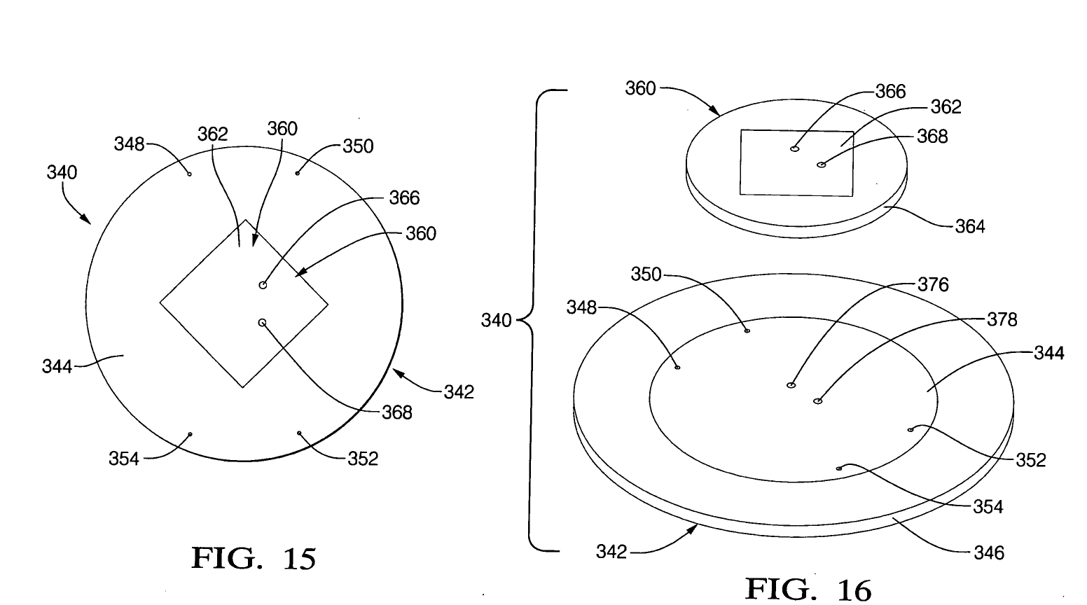

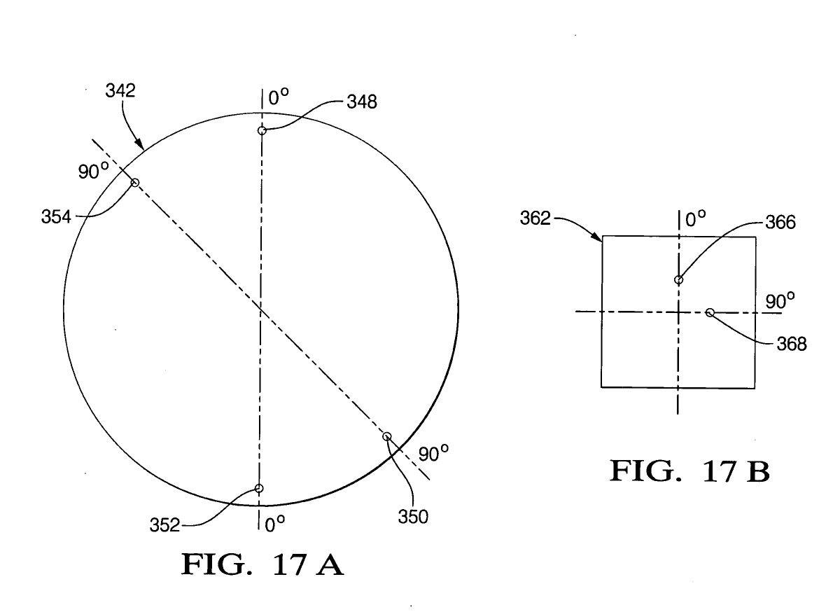

In another aspect of a stacked dual mode microstrip patch antenna 340 shown in FIGS. 15-18 includes a first antenna element 342 formed as a higher order TM21 moded circular patch antenna and a second, upper antenna element 360 formed as a lower order TM10 dual moded circular patch antenna.

The first antenna element 342 includes a patch electrode 344 fixed to a substrate 346. The substrate 346 has a permittivity of er=2.2 and a thickness of 180 mils by example only.

The first bottom patch antenna element 342 includes a plurality of probe feed bores, with four probe feed point bores 348, 350, 352 and 354 to reinforce the desired higher order TM21 mode of operation, by way of example only.

In this aspect, the patch electrode 344 for the first antenna element 342 has a diameter of about 3,250 mils for the desired center frequency of the TM21 mode.

An optional shorting pin is located at the center of the electrode 342 and electrically connected to the electrode in the bottom antenna element to diminish undesirable modes that are non-zero at the patch electrode center.

The feed bores 348, 350, 352 and 354 for the probe feed points are about 1,450 mils from the patch center, by example only, and at a specific angular location with respect to the patch electrode center.

Starting at an angular position of 0°, the first probe in bore 348 receives a 0° phase offset signal. Located at an angular position of 135°, a 90° phase offset signal is supplied to the probe in bore 350. At an angular position of 180°, a 0° phase offset signal is supplied to the probe in bore 352. Finally, a 90° offset signal is supplied to the fourth probe in bore 354 located at an angular position of 330°. This angular arrangement places the second and third probe 350 and 352 45° apart and the fourth and first probe aperture 354 and 348 also 45° apart.

All of the probes mounted in the four feed points 348, 350, 352 and 354 can be combined with a passive feed network, not shown, to a single feed or two or more separate feeds. The probes or feed pin positions and phase angles of the feed signals may act to suppress the lower order TM11 mode of the higher order TM21 patch electrode 344.

A simulation of the TM31 moded first patch antenna element 342 shows a null at bore site (normal to antenna surface) and a maximum at about 60°. The half power beamwidth (HPBW) covers from approximately 20° to 70°. The directivity is about 5.5 to 5.5 dBi.

The upper or second antenna element 360 is formed as a lower order dual TM10 moded patch antenna having an electrode 360 and a finite substrate 362 having a diameter of 3,000 mils, a permittivity of er=3.4 and a thickness of 180 mils, all by example. Simulated data determined that the patch antenna electrode 360 should be square with dimensions of 1,250 mils on a side for the desired center frequency.

The dual TM10 mode patch electrode 362 uses two probe feed points in bores 366 and 368 respectively driven by 0° and 90° phase offset signals to create the desired TM10 mode in orthogonal directions. The feed point bores 366 and 368 are offset from the patch center along the center lines in both the x and y directions by about 250 mils.

The probes mounted in the feed points 366 and 368 may be combined with a passive feed network into a single feed or separated into two or more feeds.

Bores 376 and 378, are formed in the electrode 342 and in the substrate 344 of the first antenna element 340 for passage of the probes through the first antenna element 340 and into the feed bores 366 and 368 in electrical contact with the electrode 362 of the second antenna element 360.

The dual TM10 moded patch antenna 360 was directed at bore site (normal to antenna surface). The half power beam width (HPWB) covers from approximately to −46° to =46°. The directivity was about 7.0 dBi.

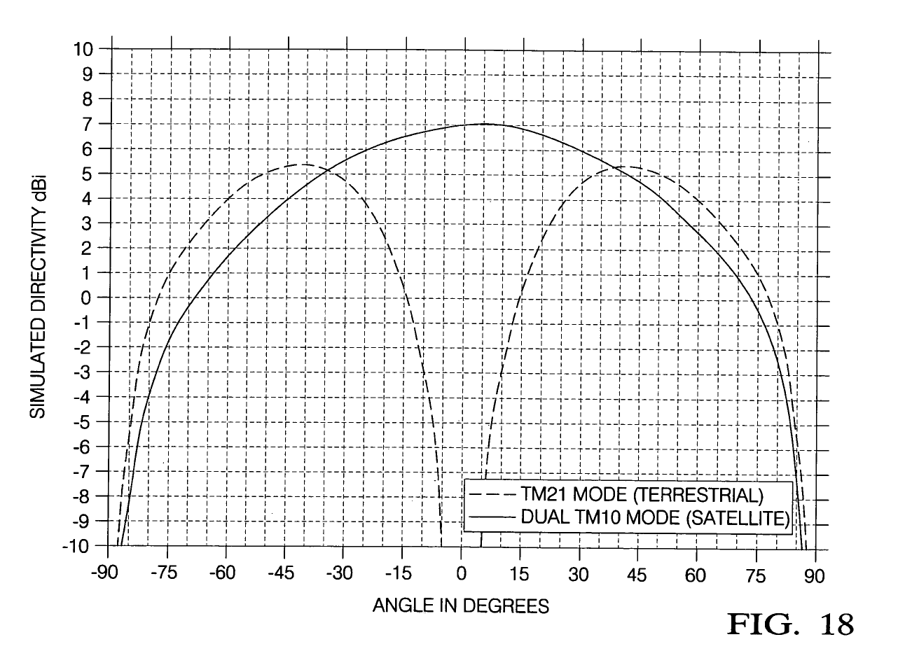

The radiation pattern for circular polarized directivity is shown in the graph in FIG. 18 for both antenna elements 342 and 360.

Simulations show that the antenna 340 should provide about +6 dB in satellite signal gain improvement and a significantly improved angular coverage to low observation angle (close to horizontal) for terrestrial signals.

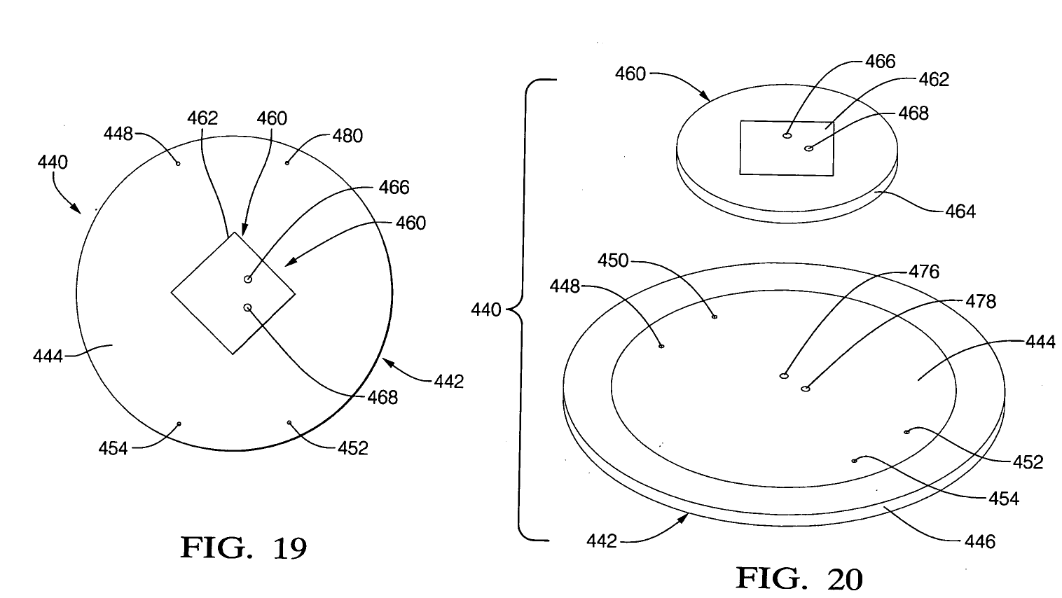

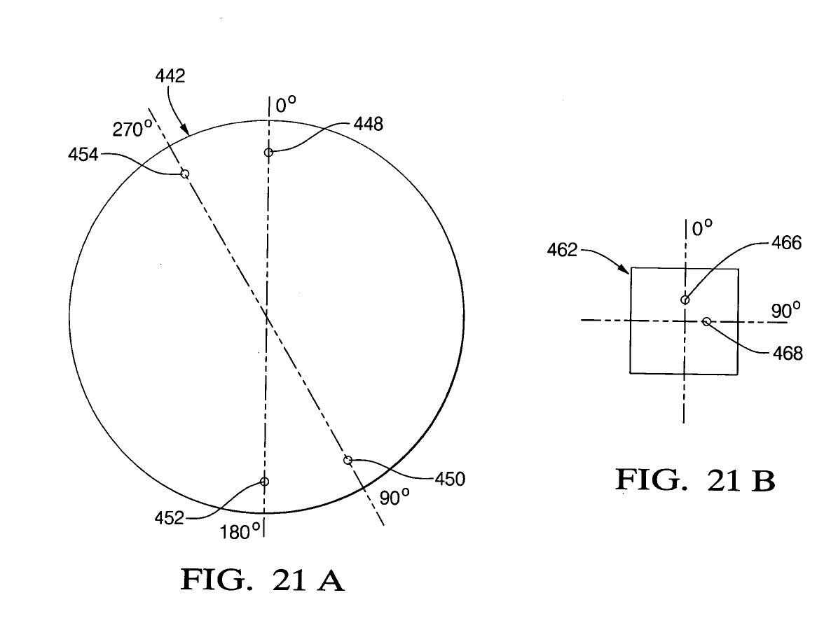

In another of a stacked dual mode microstrip patch antenna 440 shown in FIGS. 19-22, a first bottom antenna element 442 is a higher order TM31 moded circular patch antenna and the second or upper antenna element 460 is a lower dual order TM10 moded circular patch antenna.

The first antenna element 442 includes a patch electrode 444 fixed to a substrate 446. The substrate 446 has a permittivity of er=2.2 and a thickness of 180 mils by example only.

The first bottom patch antenna element 442 includes a plurality of probe feed bores, with four probe feed point bores 448, 450, 452 and 454 to reinforce the desired TM31 higher order mode of operation, by way of example only. In this aspect, the patch electrode 444 for the first antenna element 442 has a diameter of about 4,700 mils for the desired center frequency of the TM31 mode.

An optional shorting pin is located at the center of the electrode 442 and electrically connected to the electrode in the bottom antenna element to diminish undesirable modes that are non-zero at the patch electrode center.

The feed bores 448, 450, 452 and 454 for the probe feed points are about 1,950 mils from the patch center, by example only, and at a specific angular location with respect to the patch electrode center.

Starting at an angular position of 0°, the first probe in the bore 448 receives a 0° phase offset signal. Located at an angular position of 150°, a 90° phase offset signal is supplied to the probe in bore 452. At an angular position of 180°, a 180° phase offset signal is supplied in bore 454. Finally, a 270° offset signal is supplied to the fourth probe in bore 454 located at an angular position of 330°. This angular arrangement places the second and third probe bores 450 and 452 30° apart and the fourth and first probe bores 454 and 448 also 30° apart.

All of the probes mounted in the feed point bores 448, 450, 452 and 454 can be combined with a passive feed network, not shown, to a single feed or two or more separate feeds. The probes or feed pin positions and phase angles of the feed signals may act to suppress the lower order TM11 mode of the higher order TM31 patch electrode 144.

A simulation of the TM31 moded patch antenna element 442 shows a null at bore site (normal to antenna surface) and a maximum at about 55°. The half power beamwidth (HPBW) covers from approximately −31° to 82°. The directivity is about 4.0 to 4.5 dBi.

The upper or second antenna element 460 is formed as a lower order dual TM10 moded patch antenna having an electrode 462 and a finite substrate 464 having a permittivity of er=2.2 and a thickness of 180 mils, all by example. Simulated data determined that the patch antenna electrode 462 should have a diameter of about 4,700 mils for the desired center of frequency.

The dual TM10 mode patch electrode 462 uses two probe feed points in bores 466 and 468 respectively driven by 0° and 90° phase offset signals to create the desired TM10 mode in orthogonal directions. The feed point bores 466 and 468 are offset from the patch center along the center lines in both the x and y directions by about 250 mils.

The probes mounted in the feed point bores 466 and 468 may be combined with a passive feed network into a single feed or separated into two or more feeds.

The dual TM10 moded patch antenna 460 was directed at bore site (normal to antenna surface). The half power beam width (HPWB) covers from approximately −46° to +46°. The directivity was about 7.0 dBi.

Bores 476 and 478 are formed in the electrode 442 and in the substrate 444 of the first antenna element 440 for passage of the probes through the first antenna element 440 and into the feed locations 466 and 468 in electrical contact with the electrode 462 of the second antenna element 460.

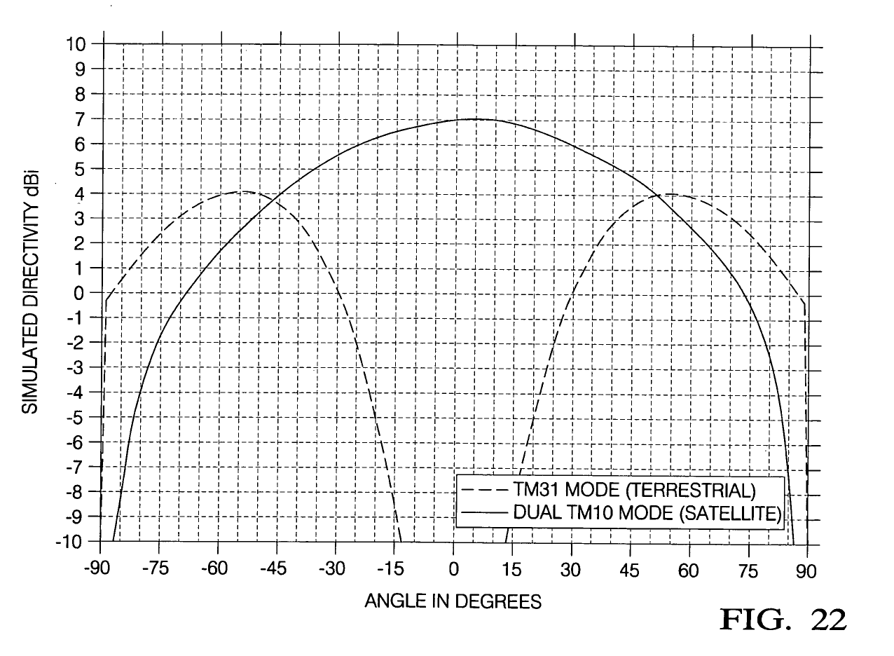

The radiation pattern for circular polarized directivity is shown in the graph in FIG. 22 for both antenna elements 442 and 460.

Simulations show that the antenna 440 should provide about +6 dB in satellite signal gain improvement and a significantly improved angular coverage to low observation angle (close to horizontal) for terrestrial signals.

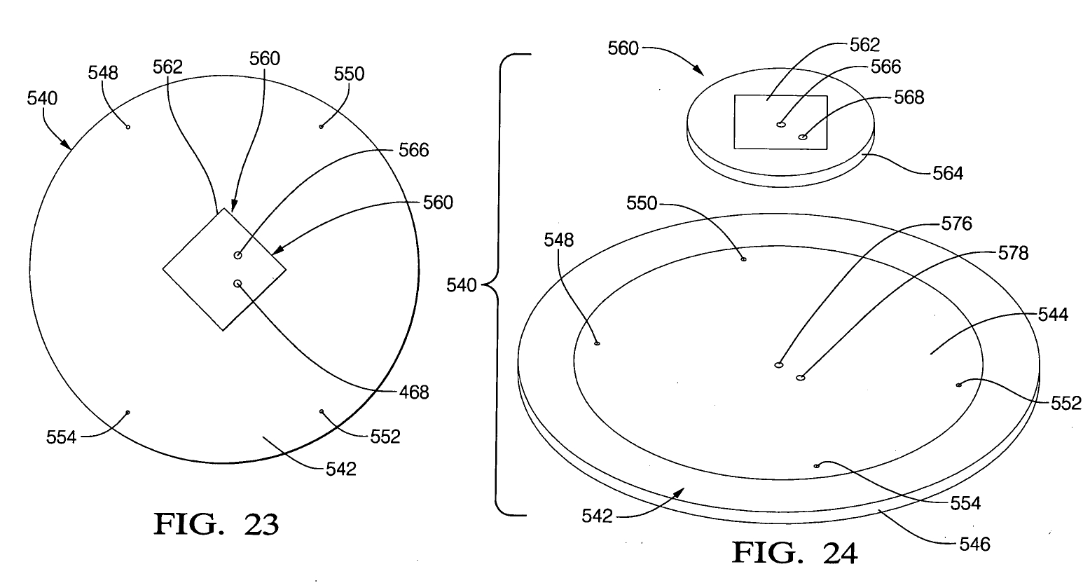

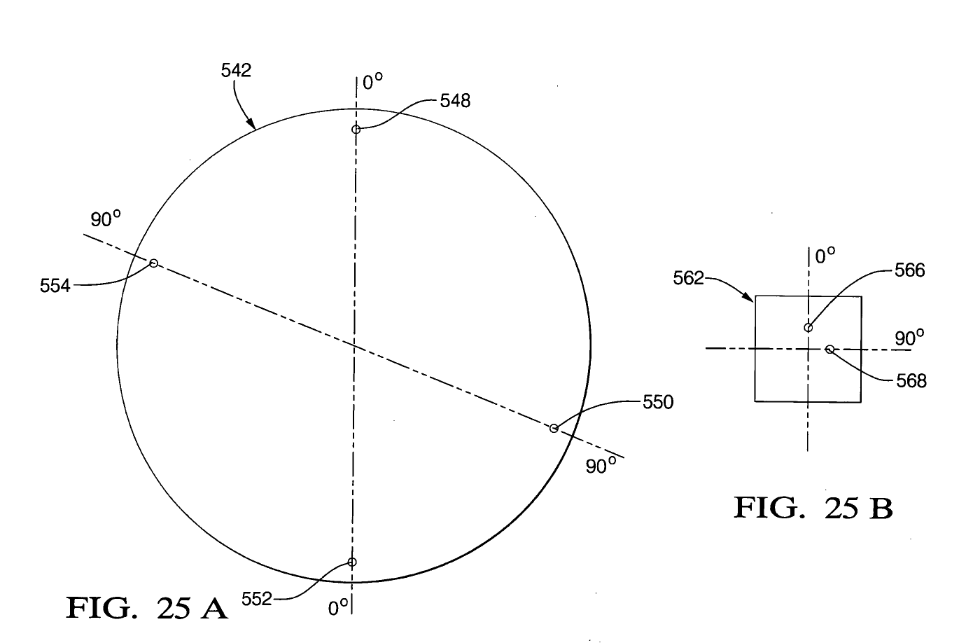

In another aspect of a stacked dual mode microstrip patch antenna 540 shown in FIGS. 23-26, the first antenna element 542 is a higher order TM41 moded circular patch antenna and the second or upper antenna element 560 is a lower order dual TM10 moded circular patch antenna.

The first antenna element 542 includes a patch electrode 544 fixed to a substrate 546. The substrate 546 has a permittivity of er=2.2 and a thickness of 180 mils by example only.

The first bottom patch antenna element 542 includes a plurality of probe feed bores, with four probe feed point bores 548, 550, 552 and 554 used to reinforce the desired higher order mode of operation, by way of example only.

In this aspect, the patch electrode 544 for the first antenna element 542 has a diameter of about 5,500 mils for the desired center frequency of the TM41 mode.

An optional shorting pin is located at the center of the electrode 542 and electrically connected to the electrode in the bottom antenna element to diminish undesirable modes that are non-zero at the patch electrode center.

The bores 548, 550, 552 and 554 for the probe feed points are about 2,500 mils from the patch center, by example only, and at a specific angular location with respect to the patch electrode center.

Starting at an angular position of 0°, the first probe in bore 548 receives a 0° phase offset signal. Located at an angular position of 112.5°, a 90° phase offset signal is supplied to the probe in bore 550. At an angular position of 180°, a 0° phase offset signal is supplied to the probe in bore 552. Finally, a 90° offset signal is supplied to the fourth probe in bore 554 located at an angular position of 292.5°. This angular arrangement places the second and third probe bores 550 and 552 67.5° apart and the fourth and first probe bores 554 and 548 also 67.5° apart.

All of the probes mounted in the four feed point bores 548, 550, 552 and 554 can be combined with a passive feed network, not shown, to a single feed or two or more separate feeds. The probes or feed pin positions and phase angles of the feed signals may act to suppress the lower order TM11 mode of the higher order TM41 patch electrode 544.

A simulation of the TM41 moded patch antenna element 542 shows a null at bore site (normal to antenna surface) and a maximum at about 60°. The half power beamwidth (HPBW) covers from approximately 40 to 80°. The directivity is about 4.5 to 5.0 dBi.

The upper or second antenna element 560 is formed as a lower order dual TM10 moded patch antenna having an electrode 562 and a finite substrate 564 having a permittivity of er=2.2 and a thickness of 180 mils, all by example. Simulated data determined that the patch antenna electrode 562 should have a diameter of about 2,500 mils for the desired center of frequency.

The dual TM10 mode patch electrode 562 uses two probe feed points in bores 566 and 568 to create the desired TM10 mode in orthogonal directions. The feed point bores 566 and 568 are offset from the patch center along the center lines in both the x and y directions by about 250 mils.

The probes mounted in the feed point bores 566 and 568 may be combined with a passive feed network into a single feed or separated into two or more feeds.

The dual TM10 moded patch antenna 560 was directed at bore site (normal to antenna surface). The half power beam width (HPWB) covers from approximately −46° to +46°. The directivity was about 7.0 dBi.

Bores 576 and 578 are formed in the electrode 542 and the substrate 544 of the first antenna element 540 for passage of the probes through the first antenna element 540 into the feed location bores 566 and 568 in electrical contact or communication with the electrode 562 of the second antenna element 560.

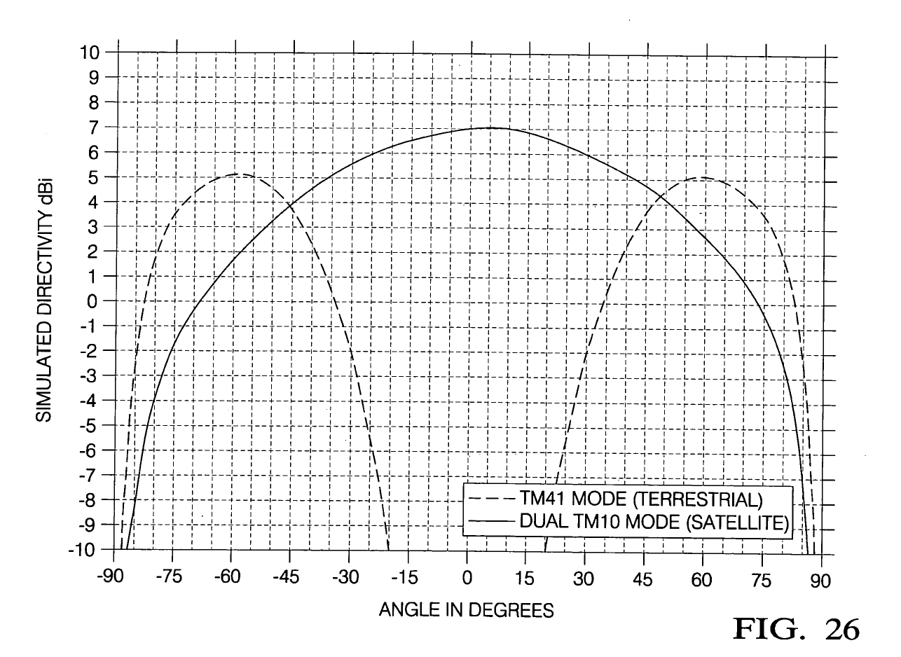

The radiation pattern for circular polarized directivity is shown in the graph in FIG. 26 for both antenna elements 542 and 560.

Simulations show that the antenna 540 should provide about +6 dB in satellite signal gain improvement and a significantly improved angular coverage to low observation angle (close to horizontal) for terrestrial signals.

What is claimed is:

1. A microstrip patch antenna apparatus comprising:
a ground plane;
a first antenna element including a first patch electrode mounted on a first substrate, the first substrate mounted on the ground plane;
a first feed conductor extending through the ground plane and the first substrate to electrical connection with the first patch electrode, the feed connection exciting the first electrode in a higher order transverse magnetic mode;
a second antenna element mounted on the first antenna element, the second antenna element including a second patch electrode and a second substrate mounted on the first antenna element; and
a second feed conductor extending through the ground plane, the first substrate and the second substrate to electrical connection with the second patch electrode, the second feed conductor exciting the second patch electrode in a lower order transverse magnetic mode.

2. The apparatus of claim 1 wherein:
the first feed conductor includes a first set of four probes extending through the ground plane and the first substrate and connected to the first patch electrode at different circumferentially spaced intervals;
the second feed electrode includes a second set of at least one probe extending through the ground plane, the first substrate and the second substrate, and connected to the second patch electrode; and
wherein each of the first set of probes are driven at different relative phase angles forcing the first patch electrode to generate a right hand circularly polarized higher order transverse magnetic mode radiation pattern.

3. The apparatus of claim 1 wherein:
the second set of probes include two probes; and
each of the second set of probes is driven at different relative phase angles forcing the second patch electrode to generate a right hand circularly polarized lower order transverse magnetic mode radiation pattern.

4. The apparatus of claim 3 wherein:
the two probes are respectively driven by 0° and 90° phase offset signals.

5. The apparatus of claim 1 wherein:
the second set of probes is excited to generate a lower order TM10 radiation pattern.

6. The apparatus of claim 1 wherein:
the second set of probes is excited to generate a lower order TM11 radiation pattern.

7. The apparatus of claim 6 wherein:
the second set of probes includes four probes spaced from a center point of the second patch electrode.

8. The apparatus of claim 1 wherein:
the first antenna element is driven in a higher order TM21 mode.

9. The apparatus of claim 1 wherein:
the first antenna element is driven in a higher order TM31 mode.

10. The apparatus of claim 1 wherein:
the first antenna element is driven in a higher order TM41 mode.

11. The apparatus of claim 1 wherein:
the first antenna element is driven in one of a higher order TM21, TM31 and a TM41 mode.

12. The apparatus of claim 1 wherein:
the second antenna element is driven in one of a lower TM10 and TM11 mode.

13. The apparatus of claim 1 wherein:
a ground plane for the second antenna element is formed by the first patch electrode.

14. The apparatus of claim 1 wherein:
the second antenna element is centered at a center null point of the first antenna element.

15. The apparatus of claim 1 wherein:
the first set of probes extends radially outward from the circumference of the second substrate.
